(19) United States
(12) Patent Application Publication
(10) Pub. No.: US 2007/0288272 A1
(43) Pub. Date: Dec. 13, 2007

(54) Collection systems and methods for managing insurance subrogation claims

(76) Inventors: Peter Tassock Marks, Portland, OR (US); David Madden, Tempe, AZ (US)

Correspondence Address: KOLISCH HARTWELL, P.C., 520 SW YAMHILL STREET, Suite 200, PORTLAND, OR, 97204, US

(21) Appl. No.: 11/818,171

(22) Filed: Jun. 12, 2007

Related U.S. Application Data
(63) Continuation-in-part of application No. 11/383,934, filed on May 17, 2006.

(51) Int. Cl. G06Q 40/00

(52) U.S. Cl. 705/4

(57) ABSTRACT

Systems and methods for managing one or more insurance subrogation claims can be utilized during the process of collecting on a claim. Various techniques can be used to assess claim information to determine, initiate, process, and/or create one or more collection events, legal actions, and/or subrogation claim documents to aid in the recovery of a claim. Civil procedure rules and collection law rules, along with predetermined claim objectives can be utilized to schedule events and trigger the automatic generation of legal and correspondence documents having claim information. Interactive and customizable presentation of claim information and determined collection events, legal actions, and/or subrogation claim documents can provide organized management of claims. Various parties interested in a claim can be in communication with the collection systems and have unique, secure, and/or defined access.

### CROSS-REFERENCE TO RELATED APPLICATIONS

This application is a continuation-in-part of U.S. patent application Ser. No. 11/383,934 entitled, “DATABASE DRIVEN SUBROGATION CLAIM MANAGEMENT SYSTEM,” filed May 17, 2006, the complete disclosure of which is herein incorporated by reference for all purposes.

### TECHNICAL FIELD

The field relates to computer-based analysis of insurance and/or legal information and processing of such information.

### BACKGROUND AND SUMMARY OF THE DISCLOSURE

It is common practice for insurance companies to reimburse clients for damages incurred in an automobile accident. Should a party other than the insured party be liable in any way for an accident, an insurance company can legally claim (e.g., pursue collection) for reimbursement from the liable party. This claim can be referred to as a subrogation claim. It can be difficult to collect from liable parties, especially when the liable party is uninsured. Under such circumstances, insurance companies often seek legal representation to assist in the recovery of these claims. Standard practice for this type of recovery process involves storing information related to the claim in a paper file, manually calendaring all claim related events and manually composing necessary court forms and correspondence. Such practice can be cumbersome, time consuming, difficult to manage and/or result in delayed communication between interested parties to the claim or missed deadlines.

The present disclosure is directed to collection systems and methods, particularly collection systems and methods configured to manage insurance subrogation claims. Examples of claim management systems and methods include Pat. Nos. U.S. Pat. No. 5,182,705, U.S. Pat. No. 5,557,515, U.S. Pat. No. 5,956,687, U.S. Pat. No. 5,991,733, U.S. Pat. No. 6,0980,70, U.S. Pat. No. 6,766,307, and U.S. Pat. No. 6,810,382; and U.S. Patent Application Publication Nos. 20040210540, 20050010454, 20050086180, 20050171819, 20050203830, and 20060116914. Examples of automated legal document systems and methods include Pat. Nos. U.S. Pat. No. 5,692,206, U.S. Pat. No. 6,122,622, and U.S. Pat. No. 7,080,076; and U.S. Patent Application Publication Nos. 20020120477 and 20050125443. The complete disclosures of the above patents and patent applications are herein incorporated by reference for all purposes:

### BRIEF DESCRIPTION OF THE DRAWINGS

FIG. 1 is a block diagram of an exemplary system for managing one or more insurance subrogation claims.

FIG. 2 is a flowchart showing an exemplary method for managing an insurance subrogation claim.

FIG. 3 is a block diagram of another exemplary system for managing one or more insurance subrogation claims.

FIG. 4 is a flowchart showing another exemplary method for managing an insurance subrogation claim.

FIG. 5 is a flowchart showing yet another exemplary method for managing an insurance subrogation claim.

FIG. 6 is a block diagram of yet another exemplary system for managing one or more insurance subrogation claims.

FIG. 7 is a block diagram of still yet another exemplary system for managing one or more insurance subrogation claims.

FIG. 8 is a screen shot of an exemplary navigation feature of an exemplary system for managing one or more insurance subrogation claims.

FIGS. 9A and 9B are screen shots of an exemplary search feature of an exemplary system for managing one or more insurance subrogation claims.

FIG. 10 is a screen shot of an exemplary claim information feature of an exemplary system for managing one or more insurance subrogation claims.

FIG. 11 is a screen shot of an exemplary involved parties information feature of an exemplary system for managing one or more insurance subrogation claims.

FIG. 12 is a screen shot of an exemplary insured party information feature of an exemplary system for managing one or more insurance subrogation claims.

FIG. 13 is a screen shot of an exemplary claimant party information feature of an exemplary system for managing one or more insurance subrogation claims.

FIG. 14 is a screen shot of an exemplary pre-judgment claim objective information feature of an exemplary system for managing one or more insurance subrogation claims.

FIG. 15 is a screen shot of an exemplary litigation claim objective information feature of an exemplary system for managing one or more insurance subrogation claims.

FIG. 16 is a screen shot of an exemplary post-judgment claim objective information feature of an exemplary system for managing one or more insurance subrogation claims.

FIG. 17 is a screen shot of an exemplary claim assessor feature of an exemplary system for managing one or more insurance subrogation claims.

FIG. 18 is a screen shot of an exemplary claimant party information summary feature of an exemplary system for managing one or more insurance subrogation claims.

FIG. 19 is a screen shot of an exemplary claimant inputs feature of an exemplary system for managing one or more insurance subrogation claims.

FIG. 20 is a screen shot of an exemplary insured party information summary feature of an exemplary system for managing one or more insurance subrogation claims.

FIG. 21 is a screen shot of an exemplary claim information summary feature of an exemplary system for managing one or more insurance subrogation claims.

FIG. 22 is a screen shot of an exemplary case inputs feature of an exemplary system for managing one or more insurance subrogation claims.

FIG. 23 is a screen shot of an exemplary judgment number input feature of an exemplary system for managing one or more insurance subrogation claims.

FIG. 24 is a block diagram of an exemplary computer system for implementing the described computer-implemented technologies.

### OVERVIEW OF TECHNOLOGIES

Collection systems and methods for managing one or more insurance subrogation claims disclosed herein could be used to aid or replace functions performed by attorneys, members of a judiciary, legislators and/or policy makers, insurance company representatives, and/or individuals. The terms ‘claim’ and ‘case’ can be used interchangeably. Similarly, any reference to entities such as law firms, insurance companies, collection companies, payment processing companies, courts, governmental agencies, technology companies and the like can also be in reference to individuals that are members or employees of such entities.

Attorneys can input initial insurance subrogation claim information, update and or register ongoing developments, and utilize systems and methods disclosed herein to automatically calendar and generate subrogation case documents. For example, an exemplary system can analyze case details within the context of applicable laws and policies on a regular timeframe (e.g., on a daily basis) to determine necessary actions to complete claim (e.g., case) objectives. Such determined actions can be initiated by a system generating subrogation case documents, including legal (e.g., court) motions, legal forms, outlines for court appearances and the like. Similarly, a system can generate correspondence letters for clients, members of adverse parties, and other related parties (e.g., the department of motor vehicles) as needed to complete one or more objectives of the claim (e.g., suspending a delinquent judgment debtor's driver's license). A system can also provide an Internet/web-based interface for various interested parties and systems to monitor the status and development of claims and access subrogation case documents and information. Further, a collection system can manage claim related accounting and create invoices for costs incurred, fees applied, damages awarded and other payments to a client, disbursements from a trust account and the like.

Members of a judiciary could also utilize the systems and methods disclosed. Judiciary members could analyze the actions of parties of a particular incident, as well as test implications of pending decisions by translating a pending decision into an inquiry in the system and inputting hypothetical cases.

Policy makers and legislators could utilize the system as a tool to test the implications of current and proposed legislation with the scope of laws and policies incorporated into the system.

Similarly, individuals could utilize the system to consider legal implications of past or prospective actions without necessarily contacting an attorney for such information.

Insurance companies, collection companies, and payment processing companies could also interact with and/or utilize the systems and methods disclosed to facilitate related functions having to do with subrogation claims.

### DETAILED DESCRIPTION OF THE DISCLOSURE

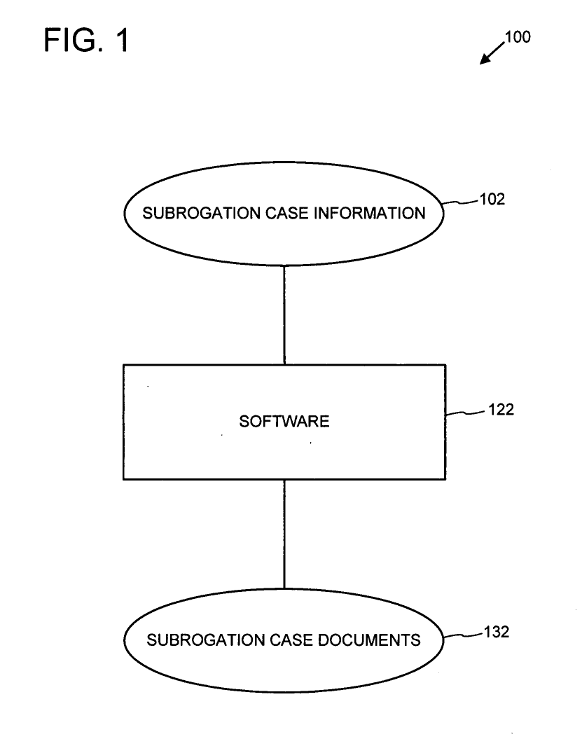

FIG. 1 shows an exemplary system 100 for managing one or more insurance subrogation claims. Subrogation case (e.g., claim) information 102 is processed by operating software 122 (e.g., software with associated hardware) to manage and/or create subrogation case documents 132. The software 122 can combine any of the technologies described herein. Subrogation case information 102 can include any information related to a subrogation claim (e.g., an automobile subrogation claim) as well as any information about any party (e.g., individual or entity) interested in the subrogation claim. For example, subrogation case information 102 can include standardized data and claim specific data.

Standardized subrogation case (e.g., claim) information can include one or more names, contact information, one or more policies in place and one or more fees charged by individuals or entities. For example, standardized information can include court data, law enforcement data, insurance company data, process server data and attorney data. Claim specific subrogation case information can include claimant information, insured party information, incident information, damage information (e.g., automobile damage information), claim objective information, and transaction information. Transaction information, for example, can include information about one or more of the following: a payment from a claimant to an attorney, a disbursement from an attorney to an insurer, a fee payment from an attorney to an organization (e.g., a court, sheriff or police office or officer, a process server, a department of motor vehicles, a search company, technology company or administration company and the like), as well as fee reimbursements from an insurer to an attorney, and any other pertinent or appropriate transaction information of interest, linked or related to a subrogation claim.

Claim objective information can include one or more prejudgment (e.g. a judgment from a court of law) objectives, one or more litigation objectives, and one or more post-judgment objectives.

Prejudgment objectives, for example, can include a number of days after obtaining a claim before sending one or more initial letters, a number of days after a verbal agreement before sending a promissory note, a number of days after a payment is overdue before sending a payment reminder letter, and a number of days after one or more lawsuit triggering events before filing a lawsuit. Examples of lawsuit triggering events can include no response to one or more initial letters, no response to a promissory note, no response to a payment reminder letter and a minimum number of days before a statute of limitations deadline.

Litigation objectives, for example, can include a number of days before a scheduled first court date before generating a trial outline, a number of days after service of a lawsuit before sending a stipulated judgment, a number of days after the earliest date allowed with no service before petitioning for a default judgment, and a number of days after sending a stipulated judgment before petitioning for a default judgment.

Post-judgment objectives, for example, can include a number of days after a payment is overdue before sending a payment reminder letter, a number of days after sending a payment reminder letter before suspending a driver's license, a number of days after an earliest date in which it is legal to suspend a driver's license before suspending the driver's license, a number of days after suspending a driver's license before garnishing one or more bank accounts, a number of days after a previous garnishment of one or more bank accounts before another garnishment of the one or more bank accounts, a number of days after suspending a driver's license before garnishing wages, a number of days after a previous garnishment of one or more bank accounts before garnishing wages, a number of days after suspending a driver's license before performing an asset check, a number of days after garnishing wages before performing an asset check, a number of days after a previous asset check before performing another asset check, a number of days before a judgment expiration date before renewing a judgment, a determination of whether to close a case when a judgment is paid in full (or after a partial payment), and a determination of whether to close a case when a claimant is bankrupt.

The subrogation case information 102 can be stored within tables in a relational database stored on a central server or on multiple separate servers or computers in communication with one another.

In any of the examples described herein, a variety of subrogation case documents 132 can be determined. For example, subrogation case documents can include legal and correspondence documents. Correspondence documents can include correspondence with insurance companies regarding an assigned case, correspondence with an insured party regarding accident information, correspondence with a claimant regarding satisfaction of a claim, correspondence with a sheriff's office or process server to request service of legal documents, and any other type of correspondence relating to a case. Legal documents can include any court document or other legal document related to the filing of a lawsuit, obtaining a judgment, or collection on a claim. For example, legal documents can include a summons, a complaint, a stipulated judgment agreement, declarations for insured parties and insurance companies, a default motion and affidavit, and entry of judgment.

The subrogation case documents 132 can be depicted via user interfaces for display and printing or communication (e.g., sent via the Internet or other communication medium such as wireless internet, facsimile, wireless telephone network and the like).

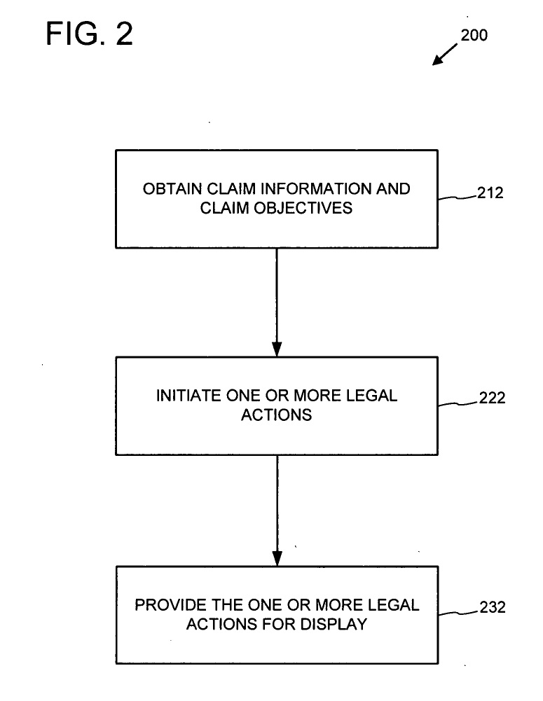

FIG. 2 shows an exemplary method 200 for managing one or more insurance subrogation claims. The method can be performed, for example, by the system 100 of FIG. 1. The method 200 and any of the other methods described herein can be performed by computer-executable instructions stored on one or more computer-readable media.

At 212, claim information and claim objectives (e.g., the subrogation case information 102 of FIG. 1) may be obtained.

At 222, one or more legal actions (e.g., the subrogation case documents 132 of FIG. 1) may be initiated. As described in the examples, a variety of legal actions can be initiated based on claim objectives and/or other case information.

At 232, the one or more legal actions may be provided for display.

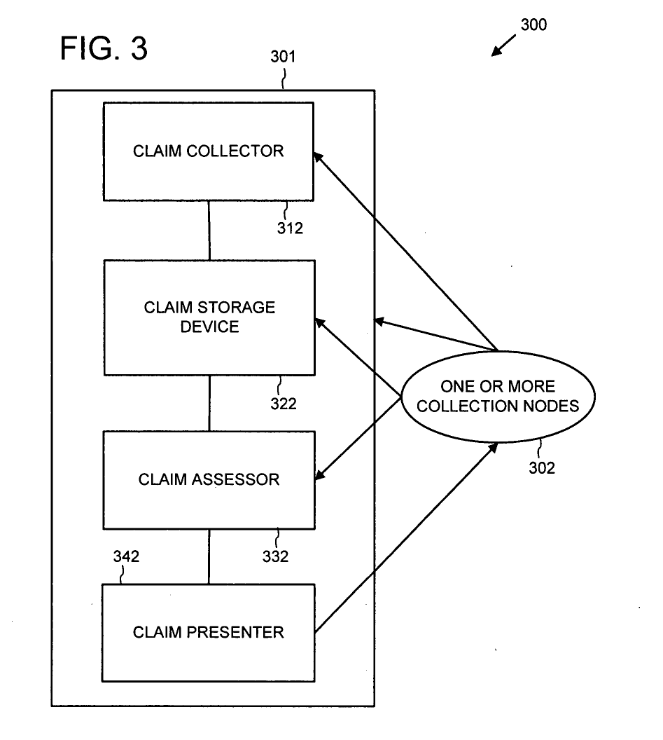

FIG. 3 shows another exemplary system 300 for managing one or more insurance subrogation claims. A claim collector 312 can obtain subrogation claim information (for example, the subrogation case information 102 of FIG. 1) from one or more collection nodes 302. A claim storage device 322 can store the subrogation claim information obtained by the claim collector 312.

A claim assessor 332 can determine one or more collection events (for example, the initiation of one or more legal actions 222 of FIG. 2) based at least on the subrogation claim information obtained and stored. The determination of one or more collection events can be further based on at least one of civil procedure (e.g., one or more civil procedure rules) and collection law (e.g., one or more collection law rules). Further, claim assessor 332 can generate one or more subrogation documents (for example, the subrogation case documents 132 of FIG. 1) based at least on the claim information and the more or more collection events determined.

A claim presenter 342 can present at least one of the one or more subrogation documents and the claim information and be in communication with the one or more collection nodes 302.

Claim collector 312, claim storage device 322, claim assessor 332 and claim presenter 342 can represent a collection system 301 for managing one or more insurance subrogation claims in communication with one or more collection nodes 302. Software 122 of FIG. 1 can be utilized in collection system 301.

A collection node (for example, the one or more collection nodes 302) can include a device operable by person or a computer system. An exemplary person that can operate a collection node device can include a claimant, a collection system administrator, an insurance administrator, an insurance adjustor, an insured party, an attorney or any other person having interest in or association with a claim. An exemplary collection node computer system can include an electronic insurance record system, an electronic payment system, an electronic judicial record system and an electronic communication system (e.g., an automated messaging system, an email messaging system, or the like). A collection node can be configured to receive and/or store claim information, as well as disperse and/or present claim information. Collection nodes are not limited to collecting information, and can be alternatively referred to as information nodes and/or interface nodes and the like.

The one or more collection nodes 302 can be in communication with claim collector 312, claim presenter 342, collection system 301 generally, and even with claim storage device 322 or claim assessor 332. The communication can be via manual input, viewing/display, or via interactive read and/or write communications utilizing software, hardware, or any combination thereof.

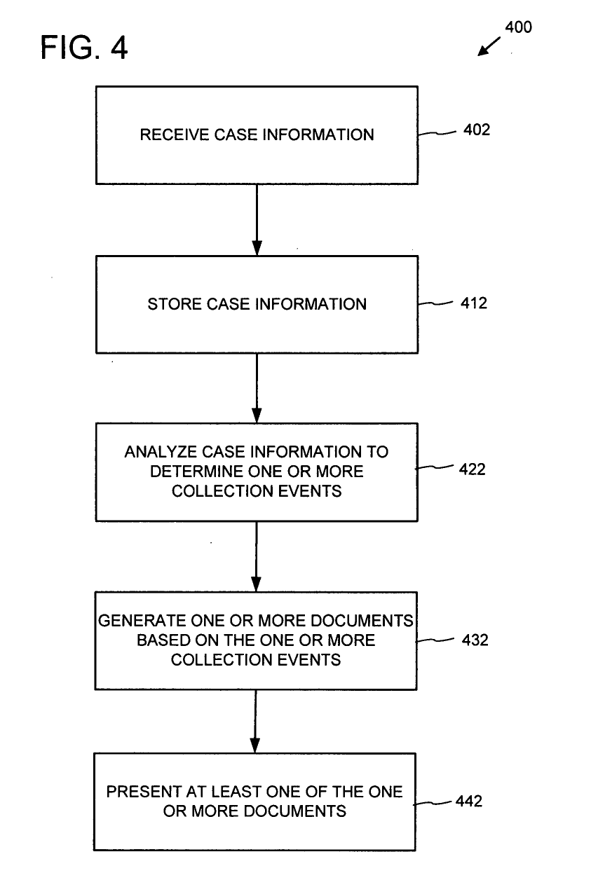

FIG. 4 shows another exemplary method 400 for managing an insurance subrogation claim. The method can be performed, for example, by the system 300 of FIG. 3. The method 400 and any of the other methods described herein can be performed by computer-executable instructions stored on one or more computer-readable media.

At 402, case information (e.g., the subrogation case information 102 of FIG. 1) is received. For example, claim collector 312 of system 300 can receive case information.

At 412, case information is stored. For example, claim storage device 322 of system 300 can store case information. Case information can be stored in tables in a relational database or in any other database or storage system. The database can be stored on one computer, a central server accessible through the Internet, an intranet or other means, or even on multiple computers or servers in a distributed computing architecture.

An exemplary relational database can be structured as follows. Columns in each database table can represent a category of data and be identified by a given title. Rows in each database table can represent individual instances and be identified by a system generated reference number. Columns can be restricted by the type of data input. Exemplary data type restrictions include string (e.g. character input restriction), numeric (e.g., numerical value input restriction), date (e.g., a date in a month/day/year with time stamp or any other format), and any other type of appropriate data restriction desired. Numeric data in a column can sometimes be used as a reference number to refer to a row in another table.

Exemplary system tables can include case, law firm, attorney, objective, client, involved individual, involved company, cost, bill, disbursement state, county, district, zip code, sheriff office, and process server tables.

A case table can include all applicable reference numbers, references to clients, references to adverse parties, objective information and references, a description of an incident, the date and location of an incident, a description of resulting damages, costs of resulting damages, transactions made by a client relating to an incident, information on a court judgment resulting from an incident, information on a client's fee arrangement, dates that specific documents were sent and received, one or more objectives of a case (e.g., a “recover incurred loses” objective), and one or more limitations on pursing an objective (e.g., a cost budget, omission of selected legal practices, and the sort).

A law firm table can include a law firm's name, address, contact information, fee information, as well as information for use by a collection system including use, login and system fee information.

An attorney table can include a full name and salutation of an attorney, use and login information, as well as a reference to a law firm table. Rows in an attorney table can be referenced by a bar membership table that can include the number and state of a bar membership.

An objective table can include the name of an objective (e.g., obtain a judgment), a priority level, a date initiated, a criteria for completion, a date completed, a criteria for failure, a date failed, a sequence of actions needed to satisfy completion of an objective, and information on completion of actions needed to satisfy completion of an objective.

A client table can include information on current fee arrangements (e.g., contingency fee, hourly fee, and default judgment fee), billing arrangement, billing interval, disbursement interval, and other miscellaneous fees. A client table can also include client default objective limitations for new cases (e.g., fee budgets of procedural omissions). Further, a client table can reference an involved party and could include rows in other tables (e.g., an involved individual table or involved company table). A client table can also be referenced by a client representative table that can include a client representative's name and salutation as well as user and login information. Rows in a client representative table can be referenced by tables including an involved individual table, involved company table, cost table, bill table, disbursement table, state table, county table, district table, zip code table, sheriff office table, and process server table.

An involved individual table can include an involved individual's contact information, identification information (e.g., driver's license state and number, social security number, and the like), significant involvement information (e.g., a bankruptcy filing, military service, and the like), information relating to involvement in an incident/accident, information on transactions related to an incident/accident, property description (e.g., an automobile involved in an accident in an automotive subrogation case/claim), property damage description, personal injury description, payment arrangement, insurance coverage information (with a reference to the involved individual's insurance company in the involved company table), dates specific documents were sent, dates specific documents were received, and login information.

An involved individual table can be referenced by an involved individual names table, a represented party address table, a represented party employer table, a represented party bank account table, a represented party payment table, and an adverse party garnishment table. An involved individual name table can include one or more names and salutations of a represented party (e.g., a full name on a birth certificate, an alias, or any other name) and whether or not the one or more names are currently being used. A represented party address table can include a represented party's street address and whether or not an address is currently active or not. A represented party employer table can include a represented party's employer, employer address, past garnishment information, and whether the represented party's employer currently employs an adverse party. A represented party bank account table can include a represented party's bank account number, the name and address of the bank the account is held at, the bank account's past garnishment information and whether or not the bank account is currently open. A represented party payment table can include a date a payment was received from a represented party, an amount of a payment and a method of a payment (e.g., cash, check, credit card, money order, etc.). An adverse party garnishment table can include dates that a garnishment check was issued and received, an amount of a garnishment check, and a reference to an employer or bank account that a garnishment was issued and received from.

An involved company table can include a company's name, contact information, identification information, as well as system user and login information. A cost table can include a cost name, date and amount. A bill table can include a date and amount of a generated bill, as well as whether or not a payment has been received on a generated bill. A disbursement table can include a date and amount of a generated disbursement. A state table can include a name of a state. A county table can include a county's name, a court name, a court address, and a reference to the county in which a court resides. A zip code table can include a zip code number and references to entities (e.g., a county, a district, and a sheriff's office) having jurisdiction within a zip code. A sheriff office table can include a sheriff's office's name, address, contact information, service information, and fee amounts. A process server table can include a process server's name, address, contact information, counties served, and fee amounts.

Any of the above described tables can be given alternate names. Similarly, alternative database system table architectures can be used with information stored in different tables and referenced in a variety of ways.

Returning to FIG. 4, at 422 case information can be analyzed to determine one or more collection events. Collection events can include any event of interest in the process of obtaining payment on a claim. Collection events can be associated with claim objectives, including pre-judgment objectives, litigation objectives, and post-judgment objectives in order to initiate one or more legal actions (e.g., at step 222 of method 200 of FIG. 2) and/or create one or more subrogation case documents (e.g., subrogation case documents 132 of system 100 of FIG. 1). Collection events can include sending one or more initial letters, sending a promissory note, sending a payment reminder letter, filing a lawsuit, generating a trial outline, sending a stipulated judgment, petitioning for a default judgment, suspending a driver's license, garnishing a bank account, garnishing wages, performing an asset check, renewing a judgment, closing a case, and any other event related to collecting on a claim.

At 432, one or more documents based on the one or more collection events are generated. For example, based on the case information, it can be determined that filing a lawsuit is the next step to take in proceeding with collecting a claim and a motion filing suit against a party can be generated.

At 442, at least one of the one or more documents is presented. For example, a document can be displayed on a screen or printed on a printer for presentation.

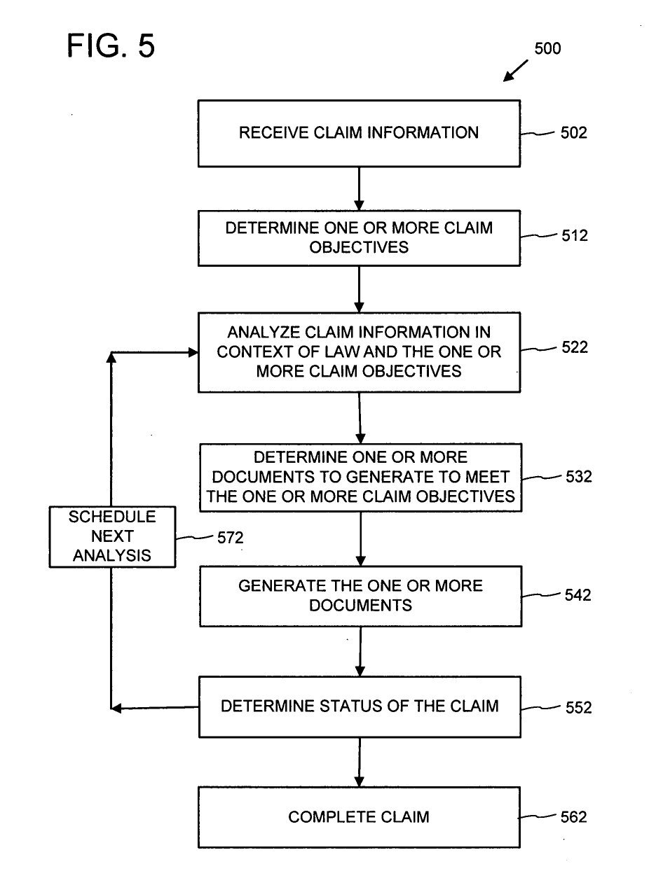

FIG. 5 shows yet another exemplary method for managing an insurance subrogation claim. The method can be performed, for example, by the system 300 of FIG. 3. The method 500 and any of the other methods described herein can be performed by computer-executable instructions stored on one or more computer-readable media.

At 502, claim information (e.g., the subrogation case information 102 of FIG. 1) is received. For example, claim collector 312 of system 300 can receive claim information.

At 512, one or more claim objectives (e.g., pre-judgment, litigation, and post-judgment objectives) are determined.

At 522, claim information is analyzed in context of law and the one or more claim objectives. The analyzing can be initiated manually, automatically or according to a scheduled timeframe (e.g., daily). For example, statutory and common laws can be translated into SQL database queries. Reference numbers of specified case table rows can be sequentially queried by each law. For example, California Code of Civil Procedure, Section 585 refers to entry of a default judgment and the following analysis in context of Section 585 can occur:
Has a case been filed? (system checks the Boolean field “ActionFiled” in a specified Case Table row). If no, the method skips to the next law for analysis. If yes, the method proceeds to the following subsequent inquiry:
Was the case filed in the state of California? (system checks the reference number in the “State” field in the row in the County Table that the “CountyFiled” filed in the Case Table refers to). If the number does not match the reference number for California, the method skips to the next law for analysis. If the number does match the reference number for California, the method proceeds to the following subsequent inquiry:
Has a judgment been reached for this case? (system checks Boolean field “Judgment?” in the specified Case Table row). If no, the method skips to the next law for analysis. If yes, the method proceeds to the following subsequent inquiry:
Did the represented party serve a summons? (system checks the “SummonsSent” column in the specified row in the CaseTable) If yes (represented party served adverse party with a summons), the method proceeds to the following subsequent inquiry:
   Has every member of the adverse party been served with a summons? (system checks Boolean field “Service” in every row in the adverse party table referencing the specified case for an answer). If no, the method skips to the next law for analysis. If yes, the method proceeds to the following subsequent inquiry:
   Has sufficient time passed to file a default motion? (system adds the number in the field “SpecifiedResponsTime” as days to the date in field “DateServed” for every row in the Adverse Party Table referencing the specified case). If no, the method skips to the next law for analysis. If yes, the method proceeds to the following subsequent inquiry:
   Has a default motion already been sent? (system checks Boolean field “DefaultMotionSent?” in the specified Case Table row). If any of the resulting dates are later than the current date, the method skips to the next law for analysis. If all resulting dates are on or earlier than the current date, the method proceeds to the following subsequent inquiry:
   Is filing a default motion necessary to complete case objectives? (system checks if this action matches an incomplete action in a row of the objective table that the specified case table row refers to as being current). If no, the method skips to the next law for analysis. If yes, the method does the following and then proceeds to the next law to analyze:
      Adds “(Case#)DefaultMotion,” to the printing instructions text string;
      Changes the “DefaultMotionSent” field in the case table to “yes”;
      Changes the “DateDefaultMotionSent” field in the case table to the current date; and
      Creates a new row in the cost table and enters the following information into the appropriate columns: case table's reference number, string “Default Motion,” the current date, the number in the “DefaultMotionFee” field in the row of the County Table that “CountyFiled” in the Case Table refers to.
If no (represented party was not served a summons by adverse party), the method proceeds to the following subsequent inquiry:
   Is filing an answer to the summons necessary to complete case objectives? (checks if this action matches an incomplete action in a row of the objective table that the specified case table row refers to as being current).
      If yes, the method adds “(Case#)AnswerFiling,” to the printing instructions text string and skips to the next law to analyze.
      If no, the method proceeds to the following subsequent inquiry:
   Is filing a counterclaim necessary to complete case objectives? (checks if this action matches an incomplete action in a row of the Objective Table that the specified Case Table row refers to as being current):
      If yes, the method adds “(Case#)CounterFiling,” to the printing instructions text string and skips to the next law to analyze.
      If no, the method proceeds to the following subsequent inquiry:
   Is requesting settlement necessary to complete the case's objective? (checks if this action matches an incomplete action in a row of the objective table that the specified case table row refers to as being current).
      If yes, the method adds “(Case#)Settlement request,” to the printing instructions text string and skips to the next law to analyze.
      If no, the method proceeds to the next law to analyze.
         Such a process can continue until every law on a list has queried every case or claim specified by a user.

Returning to FIG. 5, at 532, one or more documents are determined to be generated in order to meet the one or more claim objectives. For example, printing function text strings resulting from step 522 can be interpreted as instructions for determining which documents to generate. Unique print commands separated by commas can be searched for within a printing function text string. Such print commands can include the case reference number (or involved party reference number) and a document reference in the form of “(Case#/Party#)DocumentName,”. For example, string “24Complaint, 24Summons” refers to a complaint document for case 24 and a summons document for case 24. Similarly, printing tags can be created by querying the print command's reference number for a list of information in its row or any row it refers to. SQL functions and other commands can modify the resulting list into strings. For example, print tag “DateOfLoss” can output the date in the DateOfLoss field in the case table in Month Day, Year format (e.g., Jun. 5, 2006). Similarly, for example, print tag “AccidentLocation” can output one of the following: if one street is listed in the case table, output “StreetA” (e.g., Exposition Boulevard), and if two streets are listed in the case table, output “StreetA and StreetB” (e.g., Exposition Boulevard and Vermont Street). The print command's document reference can be matched to select an appropriate document template. The print command's reference number can be queried to determine an appropriate file. For example, if a print command is “complaint” then command=complaint. Following this example, subsequent analysis of the command's reference number can be as follows:

If PropertyDamage=0, MedicalExpenses>0, NonEconomicDamages=0, AttorneyFees=0, select document, “Complaint_Med.doc.”

If PropertyDamage=0, MedicalExpenses>0, NonEconomicDamages=0, AttorneyFees>0, select document, “Complaint_MedFees.doc.”

If PropertyDamage=0, MedicalExpenses>0, NonEconomicDamages>0, AttorneyFees=0, select document, “Complaint_MedNe.doc.”

If PropertyDamage=0, MedicalExpenses>0, NonEconomicDamages>0, AttorneyFees>0, select document, “Complaint_MedNeFees.doc.”

If PropertyDamage>0, MedicalExpenses=0, NonEconomicDamages=0, AttorneyFees=0, select document, “Complaint_Prop.doc.”

If PropertyDamage>0, MedicalExpenses=0, NonEconomicDamages=0, AttorneyFees>0, select document, “Complaint_PropFees.doc.”

If PropertyDamage>0, MedicalExpenses>0, NonEconomicDamages=0, AttorneyFees>0, select document, “Complaint_PropMedFees.doc.”

If PropertyDamage>0, MedicalExpenses>0, NonEconomicDamages>0, AttorneyFees=0, select document, “Complaint_PropMedNe.doc.”

If PropertyDamage>0, MedicalExpenses>0, NonEconomicDamages>0, AttorneyFees>0, select document, “Complaint_PropMedNeFees.doc.”

Returning to FIG. 5, at 542 the one or more documents determined are generated. For example, a server-side automation find and replace application such as “Aspose.Words” (Aspose Pty Ltd. of Sydney, Australia) or any other similar application can be utilized to search a selected document template for pre-defined unique text strings and replace them with a list of created printing tags. For example, all @#DateOfLoss@# strings in a document “Complaint_PropMed.doc” can be replaced with a date of loss (e.g., Jun. 5, 2006). Similarly, for example, all @#CaseStreets@# strings in a document “Complaint_PropMed.doc” can be replaced with “Exposition Boulevard and Vermont Street.” Additionally, XML can be utilized to create tables in generated documents (e.g., tables within billing documents). Each document created can be saved with a name that allows for an organized file directory. For example, documents can be created according to the following template, “(Case#/Party#)DocumentName.doc”. Following the example previously described, document “24Complaint_PropMed.doc” can be saved.

At 552, after generating one or more documents the status of the claim can be determined. If the claim is incomplete (e.g., case objectives have not been met), method 500 can continue by scheduling an additional analysis at step 572. When the scheduling requirement is met, method 500 returns to step 522. If the claim has met case objectives, then the claim is completed (e.g., closed and/or marked as closed or complete) at step 562.

Exemplary documents that can be generated for an automobile subrogation claim in the state of California can include the following:

CA Document Title

1_AttBill.doc
1_InsBill(2).doc
982a5(Dismissal).doc
982a6(Default).doc
982a6(Judgment).doc
Acknow1.doc
AssetCheck.doc
CIV109.doc
CIV123.doc
Close.doc
CM010(Limited).doc
CM010(Unlimited).doc
Complaint(AcctStated).doc
Complaint(PD)(AcctStated).doc
Complaint(PD)(UMBI)(AcctStated).doc
Complaint(PD)(UMBI).doc
Complaint(PD).doc
Complaint(UMBI)(AcctStated).doc
Complaint(UMBI).doc
DCLR(AcctStated).doc
DCLR(InsComp)(1UMBI)(PD).doc
DCLR(InsComp)(1UMBI).doc
DCLR(InsComp)(2UMBI)(PD).doc
DCLR(InsComp)(2UMBI).doc
DCLR(InsComp)(PD).doc
DCLR(Insured)(PD).doc
DCLR(Insured)(UMBI)(PD).doc
DCLR(Insured)(UMBI).doc
DCLR(Venue).doc
Demand.doc
DL30.doc
EJ001.doc
EJ130(BankGarnishment).doc
EJ130(WageGarnishment).doc
Envelope(BSheriff).doc
Envelope(Claimant).doc
Envelope(CSheriff).doc
Envelope(DistrictCt).doc
Envelope(ESheriff).doc
Envelope(Insured).doc
Envelope(Insurer).doc
Envelope(Recorder).doc
Garnishment.doc
Installments(Order).doc
Installments(Stipulation).doc
Insured.doc
JDExam.doc
JUD100.doc
JudgeNote.doc
Loss.doc
MC012.doc
PaidInFull.doc
PromissoryNote.doc
RecorderLetter.doc
Reminder.doc
Sheriff(BankGarnishment).doc
Sheriff(JDExam).doc
Sheriff(Keeper).doc
Sheriff(Summons).doc
Sheriff(TillTap).doc
Sheriff(WageGarnishment).doc
SUM100(Summons).doc
Test.doc

For example, a complaint document can include the following exemplary unique text strings and associated print instructions:

| TEXT STRING | PRINT INSTRUCTION |
|---|---|
| @#StateU@# | The name of the state in the STATE table that the |
| | “StateFiled” field in the CASE table refers to printed in |
| | upper case letters from a SQL command. |
| @#CountyFiledU@# | The name of the county in the COUNTY table that the |
| | “CountyFiled” field in the CASE table refers to, printed |
| | in upper case letters from a SQL command. |
| @#PlaintiffU@# | The full names of the insured party members |
| | (“FirstName” + “LastName” in the INSURED table) |
| | with names separated by spaces printed in upper case |
| | letters from a SQL command if the “Plaintiff” field in |
| | the CASE table is positive (meaning file in the name of |
| | the insured). The name of the insurance company |
| | referred to in the “Insurer” Field of the CASE table |
| | printed in upper case letters from a SQL command if |
| | the “Plaintiff” field in the CASE table is negative |
| | (meaning file in the name of the insured). |
| @#DefendantU@# | The full names of all claimants (“FirstName” + “LastName” |
| | of each individual claimant in the |
| | CLAIMANT table) with names separated by spaces and |
| | printed in upper case letters from a SQL command. |
| @#Exceeds10K@# | If the sum of the “PropertyDamage” field in the CASE |
| | table and the “MedicalExpenses” and |
| | “NonEconomicDamage” fields in the INSURED table |
| | minus the “AmountPaid” field in each CLAIMANT |
| | table exceeds $10,000, print “Demand exceeds |
| | $10,000”. If not, print “Demand does not exceed |
| | $10,000”. |
| @#AccidentStreets(s)@# | If only “AccidentStreet1” is entered (not “0”) in the |
| | CASE table, print “[AccidentStreet1] was, and is now, a |
| | dedicated public roadway”. If both “AccidentStreet1” |
| | and “AccidentStreet2” are both entered (not “0”) in the |
| | CASE table, print “[AccidentStreet1] and |
| | [AccidentStreet2] were and are now, dedicated public |
| | roadways”. |
| @#AccidentCity@# | The “AccidentCity” field in the CASE table. |
| @#AccidentCounty@# | The “AccidentCounty” field in the CASE table. |
| @#AccidentState@# | The name of the state in the STATE table that the |
| | “AccidentState” field in the CASE table refers to. |
| @#DateOfLoss@# | The DateOfLoss field in the CASE table, formatted by a |
| | SQL command to be printed “Month, DD, YYYY”. |
| @#ClaimantDriver@# | The name of the claimant (“FirstName” + “LastName” |
| | field in the CLAIMANT table) with the “Driver” |
| | boolean field positive. |
| @#ClaimantDriverRelation@# | If the Claimant Driver (as defined above) is also the |
| | owner (“Owner” field in the CLAIMANT table is |
| | positive), print “his” or “hers” depending on the |
| | Salutation field in the Claimant table (Mr. = his, |
| | Mrs./Ms = her). |
| @#PropertyDamage@# | If the vehicle was totaled (“VehicleTotaled” field in the |
| | CASE table is positive), print the sum the “CarValue”, |
| | “TowingCosts” and “RentalCosts” fields in the CASE |
| | table, minus the “SalvageValue” field in theCASE |
| | table. If the vehicle was not totaled, print the sum of the |
| | “RepairCosts”, “TowingCosts” and “RentalCosts” |
| | fields in the CASE table. |
| @#RentalTowing@# | If “TowingCosts” > 0 and “RentalCosts” > 0, print “ |
| | including towing and rental charges”. If “TowingCosts” > 0 |
| | and “RentalCosts” = 0, print “including towing |
| | charges”. If “TowingCosts” = 0 and “RentalCosts” > 0, |
| | print “including rental charges”. If “TowingCosts” = 0 |
| | and “RentalCosts” = 0, print nothing (“”). |
| @#MedicalExpenses@# | The sum of all “MedicalExpenses” fields in each |
| | INSURED table row related to the CASE table row. |
| @#NonEconomicDamage@# | The sum of all “NEDamages” fields in each INSURED |
| | table row related to the CASE table row. |
| @#AttorneyFirstName@# | Prints the “FirstName” field in the row of the |
| | ATTORNEY table that the “CaseAttorney” field in the |
| | CASE table refers to. |
| @#AttorneyMiddleInitial@# | Prints the first letter of the “MiddleName” field in the |
| | row of the ATTORNEY table that the “CaseAttorney” |
| | field in the CASE table refers to, followed by a period. |
| @#AttorneyLastName@# | Prints the “LastName” field in the row of the |
| | ATTORNEY table that the “CaseAttorney” field in the |
| | CASE table refers to. |
| @#AttorneyBarNumber@# | Prints the “BarNumber” field in the row of the BAR |
| | number table which corresponds to the row of the |
| | ATTORNEY table that the “CaseAttorney” field in the |
| | CASE table refers to as well as the row in the STATE |
| | table that the “BarState” field in the BAR table refers |
| | to. |

An exemplary template complaint document having the above noted text strings follows:

[image]

[image]

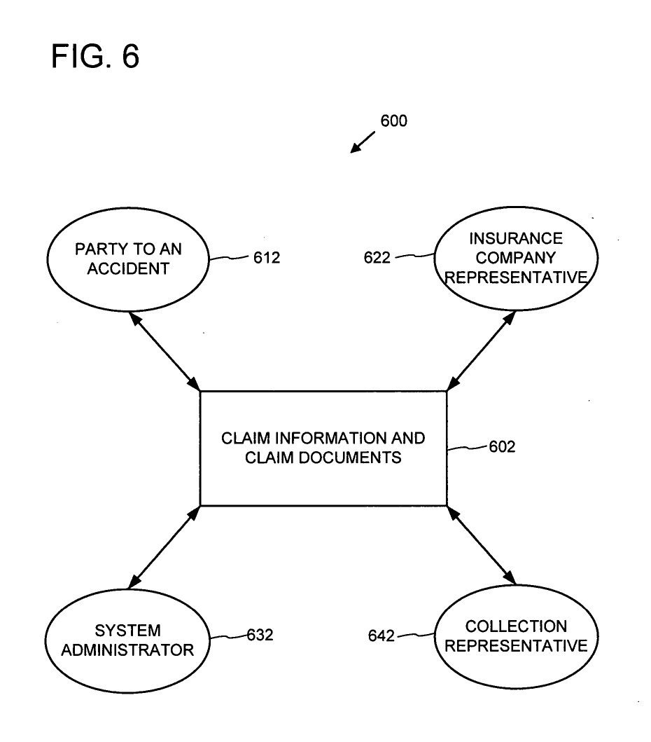

FIG. 6 shows yet another exemplary system 600 for managing one or more insurance subrogation claims. A secure communication medium (e.g., an internet/web interface) can be utilized by a person operating a device (e.g., one or more collection nodes 302 of system 300 of FIG. 3) to access claim information (e.g., subrogation case information 102 of system 100 of FIG. 1) and claim documents (e.g., subrogation case documents 1320 of system 100 of FIG. 1 and documents generated by step 542 of method 500 of FIG. 5) through a network connection.

A person can include a party to an accident 612 (e.g., a claimant or an insured party), an insurance company representative 622 (e.g., an insurance adjustor or an insurance administrator), a system administrator 632 (e.g., a technology administrator), and a collection representative 642 (e.g., an attorney, law firm representative, or collection company representative). Such persons can interact with the previously described systems and methods having access to claim information and claim documents 602.

Any security method can be utilized to ensure a secure environment when interacting with the system over a communication medium. For example, security measures to inhibit malicious attacks on the system, inhibit improper access to the system, preserve integrity of data stored within the system, and preserve integrity of messaging and communication within the system and between the system and external systems can include firewall systems, secure socket layers (SSL), password protection schemes, encryption, and the like. Users can create a new row in any table, have search functionality, view rows and input information through secure interfaces.

Hyperlinks can direct a user to the appropriate web page to create a new row in the table of their choice. The directed to web page can present the user with a comprehensive layout of data entry fields that correspond to columns in a new row of the desired table. Some fields on the data entry page can accept typed input while fields that correspond to a column that contains reference numbers to rows in other table will not accept typed input. Instead, in such fields that don't accept typed input, a user can utilize a list box (e.g., a drop down feature or selection tool) to select a reference to a particular row. The user can select a button to enter data or the page into a new row in the specified table.

Users may also search information fields in any table utilizing a search function. Users may limit a search to a specified column in a specified table.

A list of resulting matches from a search function can act as hyperlinks to a web page that presents all information in the matching row. Such a webpage can be organized in a manner that is comprehensible to a user having only limited knowledge of the collection system. Such a page can also allow a user to manually edit fields on the page and update the corresponding column in a selected row in the system database.

Users may utilize web interface input functionality to register case developments (e.g., incoming correspondence, court decisions, and the like) in the system. For example, a user can search for the reference number of the Case Table the development concerns and click on a hyperlink (e.g., an “input functions” hyperlink). The hyperlink can direct the user to a system-generated list of all potential developments that can occur given the information of the specified case table row. The user can then select the applicable development and be directed to a web page to input specific information relating to the development. The user can click on a button (e.g., a button labeled “Enter Development” or the like) to modify the appropriate fields in the system database to register the development.

Login names and passwords can allow users to access the system. For example, different users can have different access. An insurance company administrator can be given access to all of an insurance company's claims as well as have the ability to assign claims to insurance adjusters and attorneys. An insurance adjuster can have access to claims assigned to him or her to manage. An attorney or collection representative can have access to claims he or she has been assigned by an insurance company. A claimant or insured party can have access to a claim in which he or she is involved and further have the ability to make online payments. A system administrator can have access to all claims in the system and standardized data. Security access can be customized and a variety of access capabilities can be configured for users and/or groups of users.

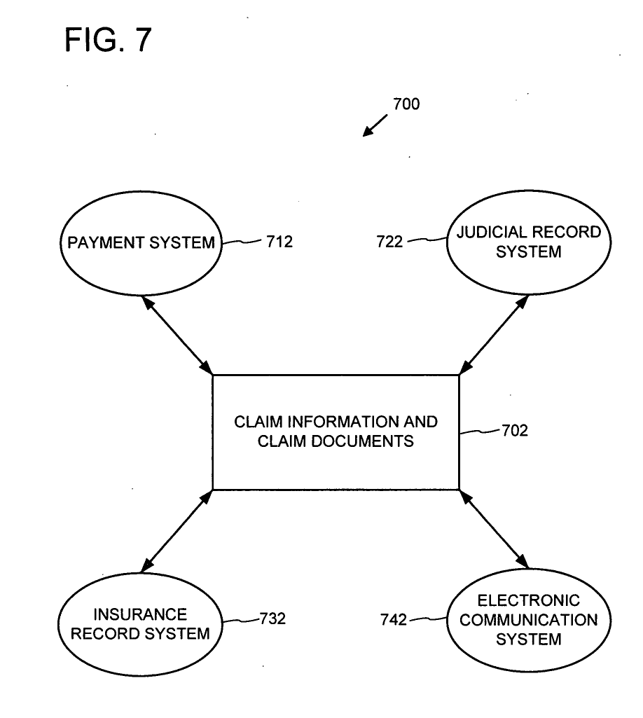

FIG. 7 shows yet another exemplary system 700 for managing one or more insurance subrogation claims. A secure communication medium (e.g., an internet/web interface) can be utilized by a computer system (e.g., one or more collection nodes 302 of system 300 of FIG. 3) to access claim information (e.g., subrogation case information 102 of system 100 of FIG. 1) and claim documents (e.g., subrogation case documents 1320 of system 100 of FIG. 1 and documents generated by step 542 of method 500 of FIG. 5) through a network connection. System 600 of FIG. 6 and system 700 of FIG. 7 can be combined in any combination. Previously described details of system 600 functionality can also be utilized in system 700.

System 700 can include a payment system 712 (e.g., any electronic payment system designed for online payment), a judicial record system 722 (e.g., an electronic judicial or court record system designed for electronic filing and docketing of court filings), an insurance record system 732 (e.g., an electronic insurance record system), and an electronic communication system 742 (e.g., an email or other communication or messaging system). Such computer systems can interact with the previously described systems and methods having access to claim information and claim documents 702. Further, electronic communication between computer systems can occur and allow for electronic filing and updating of documents and data between computer systems in system 700. For example, a subrogation case document (e.g., subrogation case documents 132 of FIG. 1) can be generated and available for viewing by a computer system in system 700. Additionally, for example, if the subrogation case document is a court filing, it can be filed electronically with judicial record system 722 and electronic communication system 742 can send emails or other communications (e.g., an email tickler advising a user to login to the collection system to view updated information) to a user or another computer system regarding the generation and/or electronic filing of the document.

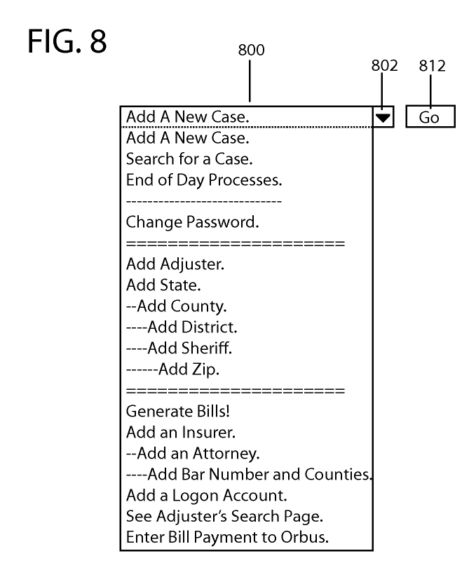

FIGS. 8-23 are screen shots of exemplary implementations of the technologies described in a web interface environment.

FIG. 8 is a screen shot of an exemplary navigation feature 800 of an exemplary system for managing one or more insurance subrogation claims. Drop down function 802 allows for the viewing of various navigation options. Navigation options can differ based on security and the type of user accessing the collection system. After highlighting and selecting a navigation option, button 812 can be selected to proceed.

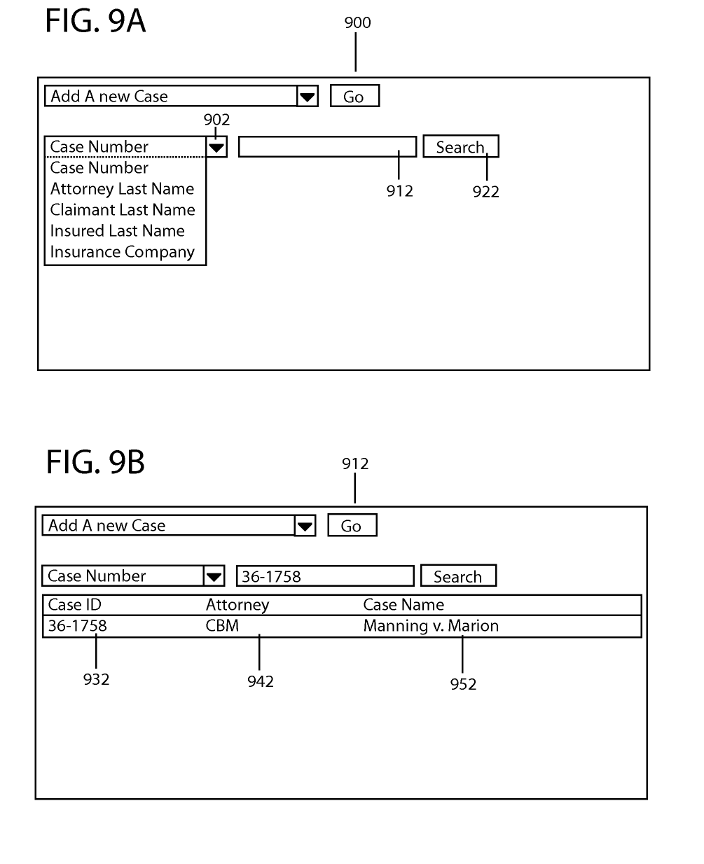

FIG. 9A is a screen shot 900 of an exemplary search feature of an exemplary system for managing one or more insurance subrogation claims. Drop down function 902 allows for search options including searching by case number, attorney last name, claimant last name, insured last name, and insurance company. Text field 912 allows for text input of an appropriate search number or term. Button 922 can be selected to proceed with a search. FIG. 9B is a screen shot displaying the result of a search of “Case Number” and “4.” Case ID field 932, Attorney field 942 and Case Name field 952 are displayed.

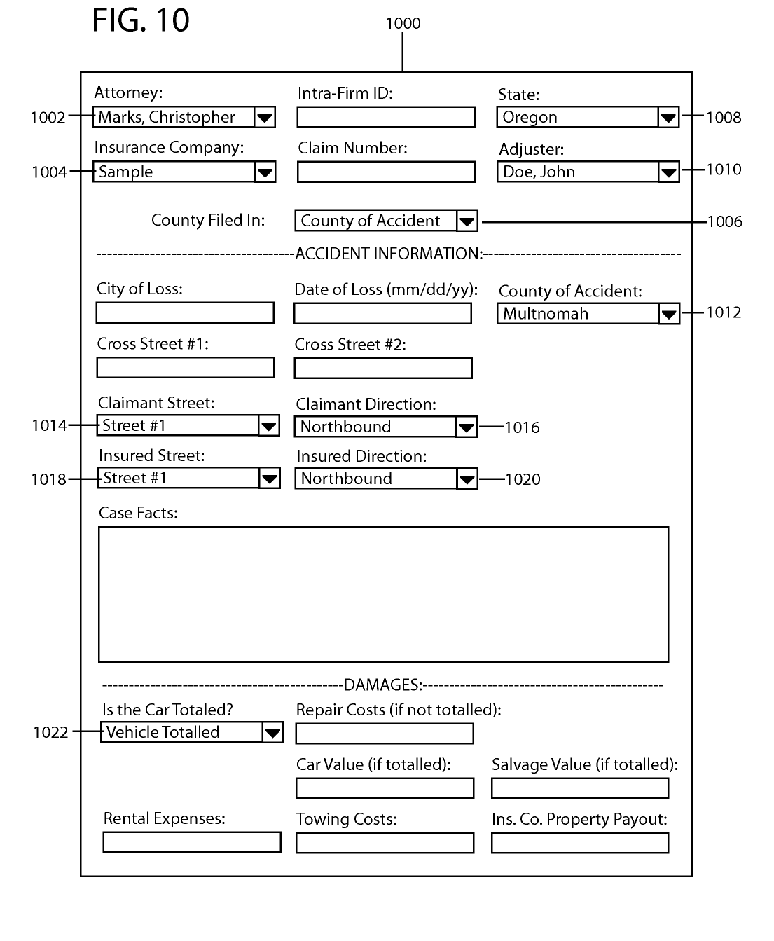

FIG. 10 is a screen shot of an exemplary claim information feature 1000 of an exemplary system for managing one or more insurance subrogation claims. Background claim information, accident information, and damages information can be input into the collection system via the claim information feature 1000. Various drop down items for specific fields can be linked to allow for linked (relational database) functionality. For example, relational data linkages can allow for drop down features for the following data fields: attorney 1002, insurance company 1004, county filed 1006, state 1008, insurance adjuster 1010, county of accident 1012, claimant street 1014, claimant direction 1016, insured street 1018, insured direction 1020 and car totalled? 1022. Upon completion of the fields in the claim information feature 1000, a user can be directed to input information about the involved parties of the claim.

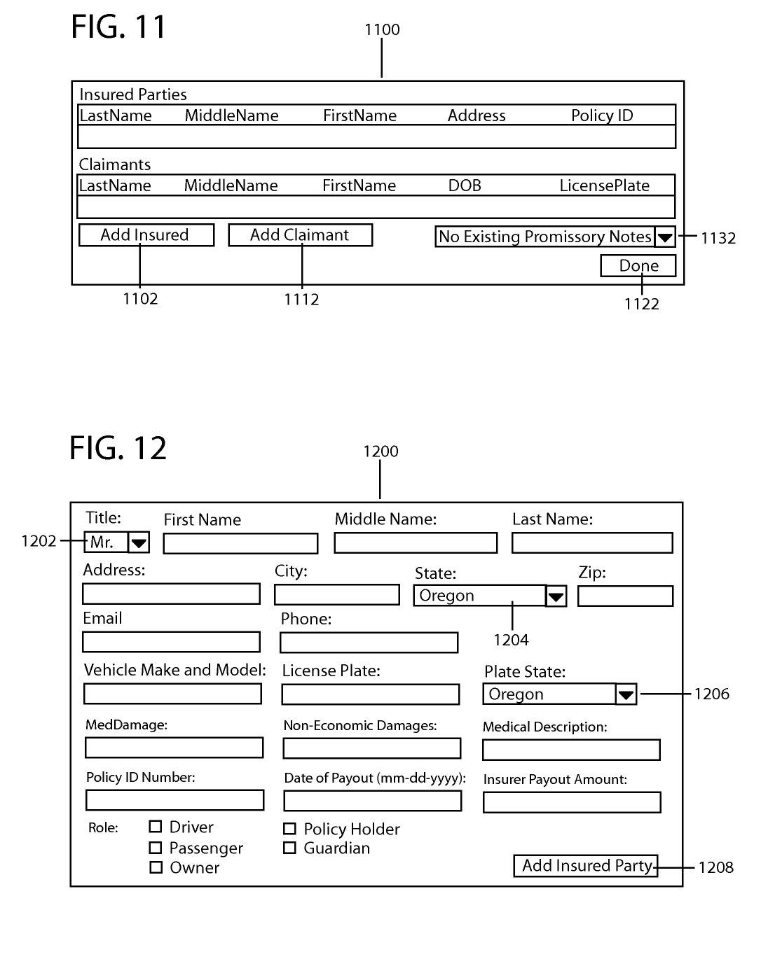

FIG. 11 is a screen shot of an exemplary involved parties information feature 1100 of an exemplary system for managing one or more insurance subrogation claims. Add an insured button 1102 can be pressed to add information about an insured party. Add a claimant button 1112 can be pressed to add information about a claimant. Done button 1122 can be pressed to complete input of information about involved parties. Drop down feature 1132 in claimant summary section of feature 1100 can be utilized to display the status of the case.

FIG. 12 is a screen shot of an exemplary insured party information feature 1200 of an exemplary system for managing one or more insurance subrogation claims. Insured party information feature 1200 can display upon a user pressing the add an insured button 1102 of feature 1100 of FIG. 11. Drop down features can include title 1202, state 1204, and plate state 1206. After information has been added, Add Insured Party button 1208 can be pressed to add the insured party information to the associated claim and cause redirection back to involved parties feature 1100 of FIG. 11.

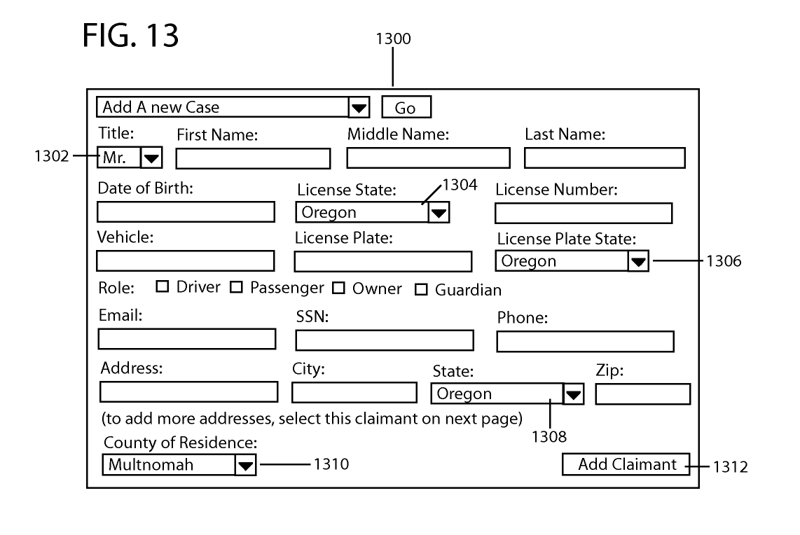

FIG. 13 is a screen shot of an exemplary claimant party information feature 1300 of an exemplary system for managing one or more insurance subrogation claims. Claimant party information feature 1300 can display upon a user pressing the Add A Claimant button 1112 of feature 1100 of FIG. 11. Drop down features can include title 1302, license state 1304, license plate state 1306, state 1308, and county 1310. After information has been added, Add Claimant button 1312 can be pressed to add the claimant party information to the associated claim and cause redirection back to involved parties feature 1100 of FIG. 11.

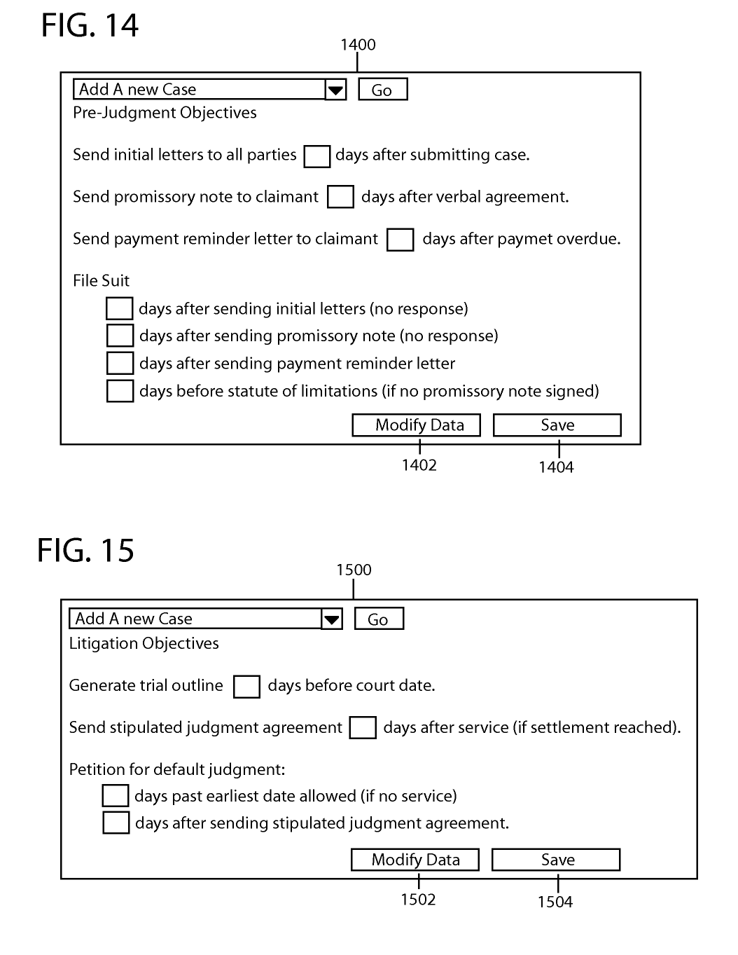

FIG. 14 is a screen shot of an exemplary pre-judgment claim objective information feature 1400 of an exemplary system for managing one or more insurance subrogation claims. Upon inputting initial information, save button 1404 can be pressed to save the pre-judgment claim objectives. If a user is updating the pre-judgment claim objectives, then modify data button 1402 can be pressed to update and modify the objectives. Buttons 1402 and 1404 can either both appear or one selectively appear according to the status of information input into the system when feature 1400 is displayed.

FIG. 15 is a screen shot of an exemplary litigation claim objective information feature 1500 of an exemplary system for managing one or more insurance subrogation claims. Similar to feature 1400, upon inputting initial information, save button 1504 can be pressed to save the litigation claim objectives. If a user is updating the litigation claim objectives, then modify data button 1502 can be pressed to update and modify the litigation claim objectives. Buttons 1502 and 1504 can either both appear or one selectively appear according to the status of information input into the system when feature 1500 is displayed.

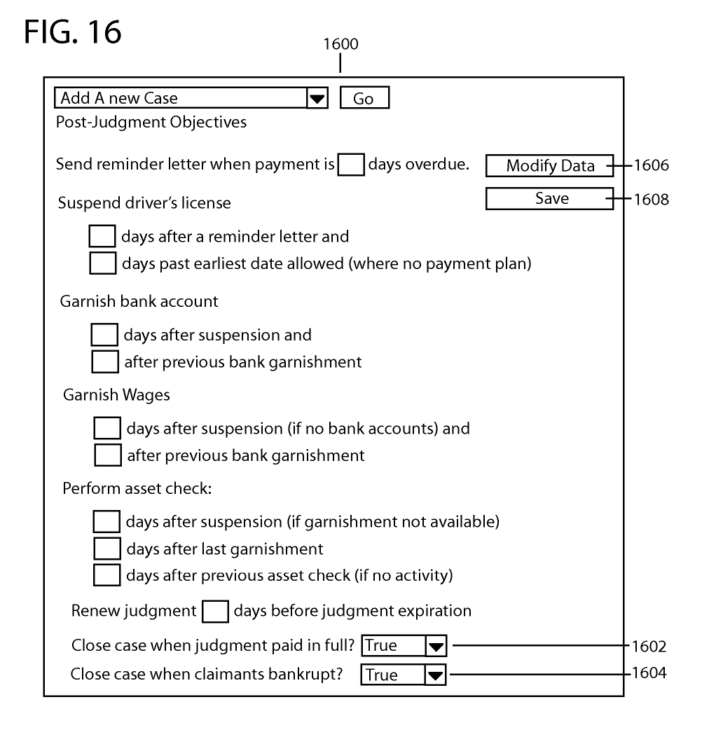

FIG. 16 is a screen shot of an exemplary post-judgment claim objective information feature of an exemplary system for managing one or more insurance subrogation claims. Similar to features 1400 of FIG. 14 and 1500 of FIG. 15, upon inputting initial information, save button 1608 can be pressed to save the post-judgment claim objectives. If a user is updating the post-judgment claim objectives, then modify data button 1606 can be pressed to update and modify the post-judgment claim objectives. Buttons 1606 and 1608 can either both appear or one selectively appear according to the status of information input into the system when feature 1600 is displayed. True/false dropdown selection features 1602 and 1604 can be utilized to determine post-judgment objectives regarding when to close a case.

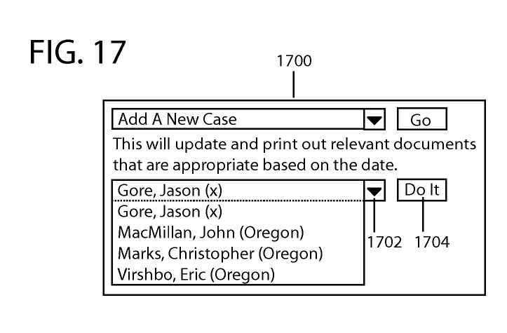

FIG. 17 is a screen shot of an exemplary claim assessor feature 1700 of an exemplary system for managing one or more insurance subrogation claims. Drop down selection feature 1702 allows for viewing and selecting one or more cases. Pressing button 1704 runs the process of updating/analyzing cases and generating one or more subrogation case documents. For example, software 122 of system 100 of FIG. 1 can be implemented by pressing button 1704. Similarly, for example, steps 422, 432, and 442 of method 400 and steps 522, 532, and 542 of method 500 can be implemented by pressing (e.g., selecting) button 1704.

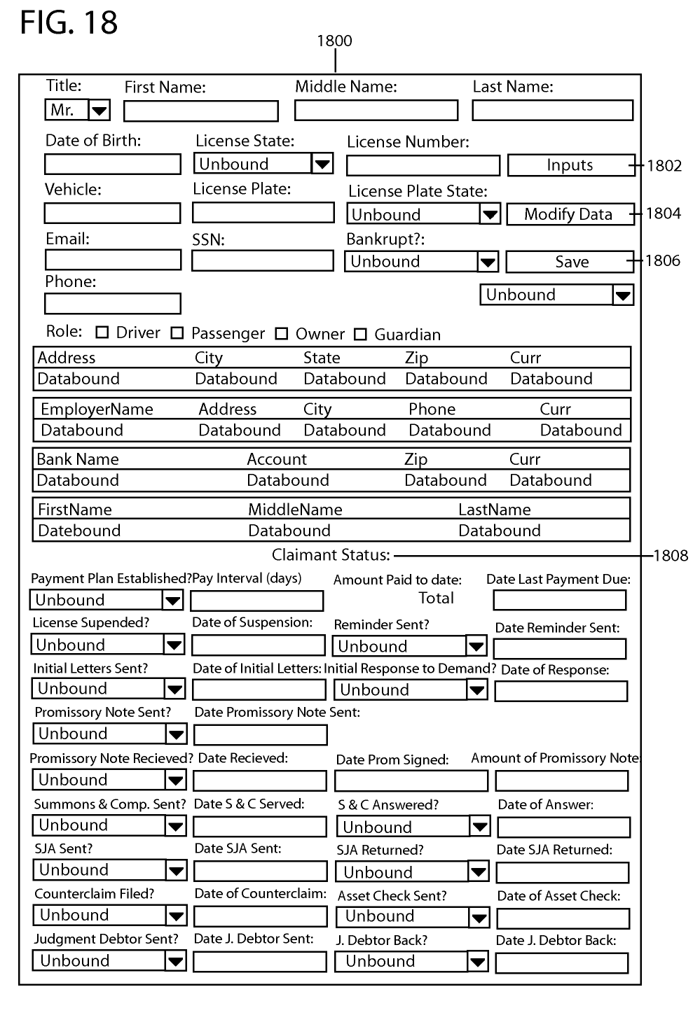

FIG. 18 is a screen shot of an exemplary claimant party information summary feature 1800 of an exemplary system for managing one or more insurance subrogation claims. Inputs button 1802 can allow a user to input new information by directing a user to a claimant inputs page. Modify data button 1804 can allow a user to modify existing data. Save button 1806 can allow a user to save information added or modified. Status of the claim can be summarized in a claimant status summary feature 1808.

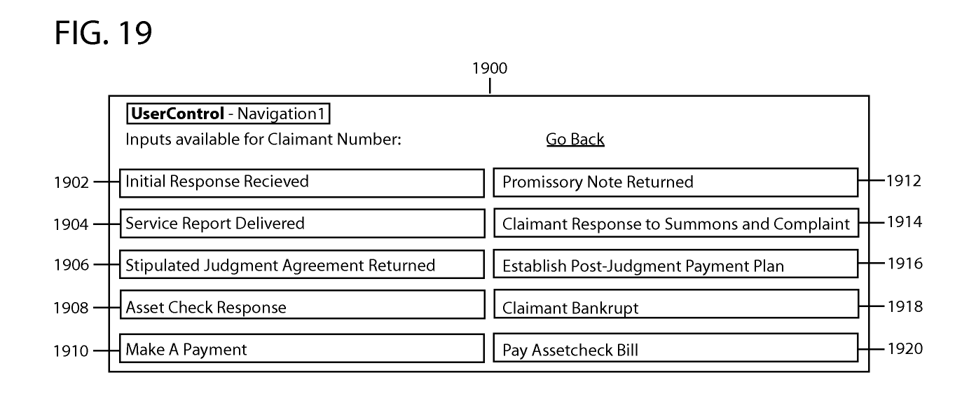

FIG. 19 is a screen shot of an exemplary claimant inputs feature 1900 of an exemplary system for managing one or more insurance subrogation claims. Claimant inputs feature 1900 can offer a user a menu of claimant related developments for the user to input. For example, a user can press inputs button 1802 in the claimant party information summary feature 1800 of FIG. 18 to be directed to the claimant inputs feature 1900. Claimant input options (e.g., buttons or selections) can include initial response received 1902, service report delivered 1904, stipulated judgment agreement returned 1906, asset check response 1908, make a payment 1910, promissory note returned 1912, claimant response to summons and complaint 1914, establish post-judgment payment plan 1916, claimant bankrupt 1918, and pay asset check bill 1920. The claimant input options feature 1900 allows for quick and/or simple updating of claimant party information applicable to the management of a claim.

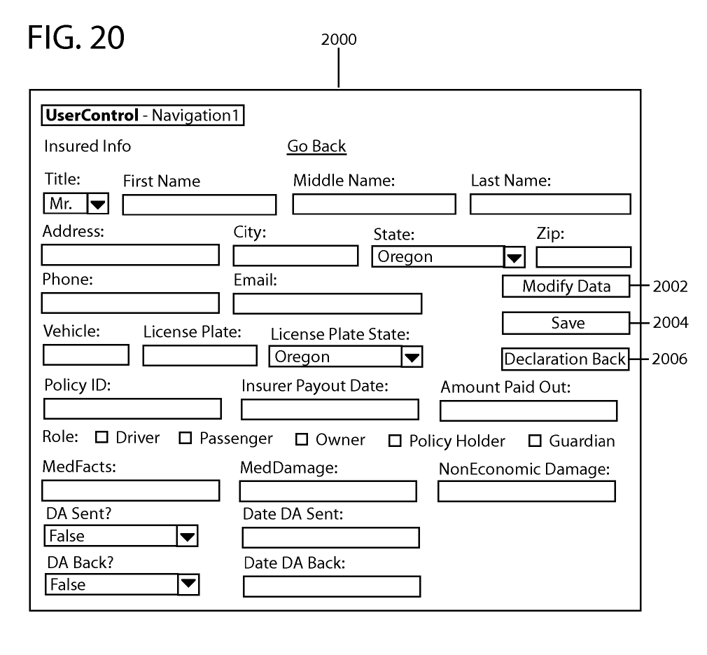

FIG. 20 is a screen shot of an exemplary insured party information summary feature 2000 of exemplary system for managing one or more insurance subrogation claims. Modify data button 2002 can allow a user to modify existing data and save button 2004 can allow a user to save information added or modified. Declaration back button 2006 is an insured party input option (similar to claimant input options found on the claimant inputs page 1900 of FIG. 19) whereby a “DA Back?” field is changed to “yes” when the declaration back button 2006 is selected. Other insured party input options could be utilized and implemented to allow for quick and/or simple updating of insured party information applicable to the management of a claim.

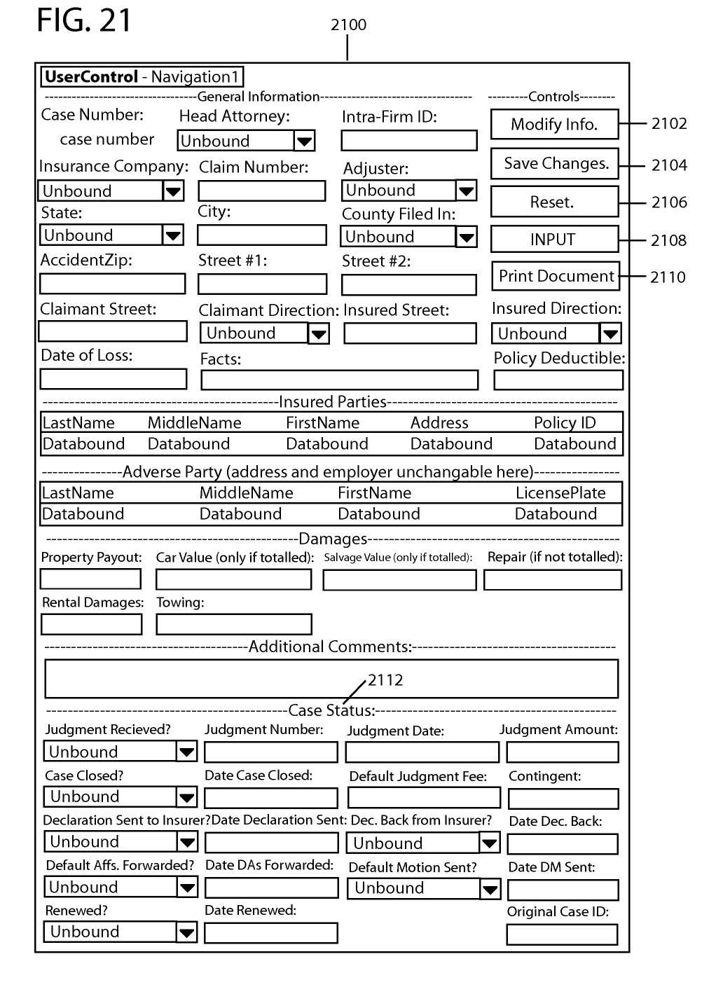

FIG. 21 is a screen shot of an exemplary claim information summary feature 2100 of an exemplary system for managing one or more insurance subrogation claims. Similar to features 1800 and 2000, various control buttons are available. Modify info. button 2102 can allow a user to modify existing data. Save changes button 2104 can allow a user to save information added or modified. Reset button 2106 can reset any changes made to fields back to the system saved fields when feature 2100 was opened. Input button 2108 can allow a user to input new information by directing a user to a case inputs page. Print document button 2110 can allow a user to print a document having information shown in the claim information summary feature 2100. Status of the claim can be summarized in a case status summary feature 2112.

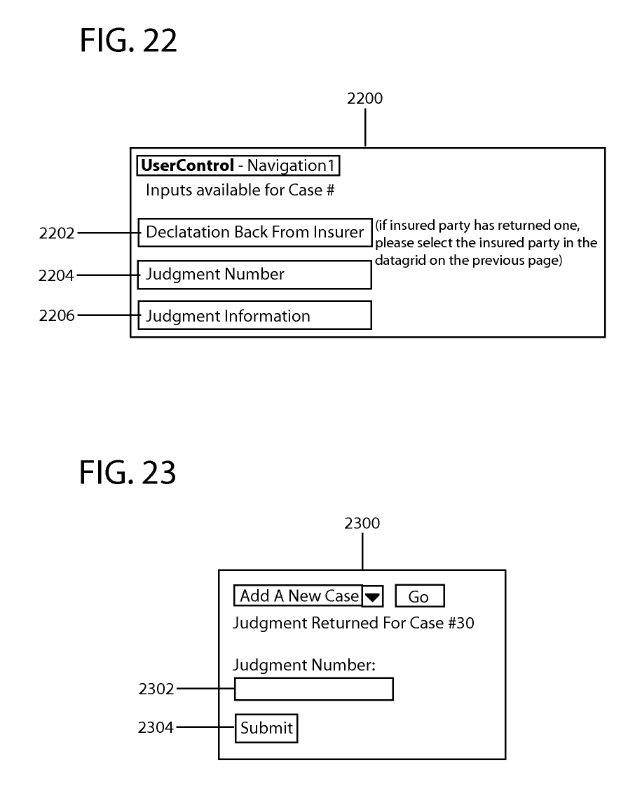

FIG. 22 is a screen shot of an exemplary case inputs feature 2200 of an exemplary system for managing one or more insurance subrogation claims. Case inputs feature 2200 can offer a user a menu of case related developments for the user to input. Case inputs options can include declaration back from insurer 2202, judgment number 2204, and judgment information 2206. Other case inputs options could be utilized and implemented to allow for quick and/or simple updating of information applicable to the management of a claim.

A menu item/input option (e.g., input button) can require only a click to register a related development or act as a hyperlink to bring the user to a subsequent page to enter more information. For example, judgment number case input option 2204 of FIG. 22 can function as a hyperlink bringing the user to a subsequent page to enter the judgment number.

FIG. 23 is a screen shot of an exemplary judgment number input feature 2300 of an exemplary system for managing one or more insurance subrogation claims. Judgment number input feature 2300 can include a judgment input field 2302 and a submit button 2304 for submitting the judgment number input entered into the input field 2302. Any of the input pages described can include functionality that determines whether or not information has been input, and only displays menu items/input options for information that has not yet been input into the system. For example, once a judgment number is entered, judgment number case input option 2204 would no longer appear on case inputs feature 2200 of FIG. 22.

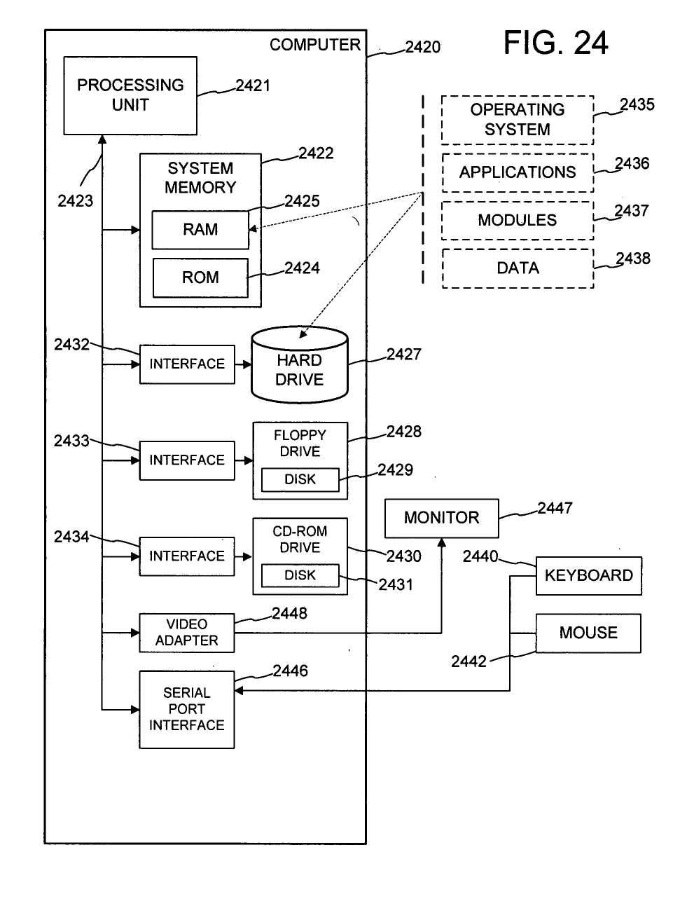

FIG. 24 and the following discussion provide a brief, general description of a suitable computing environment for the software (for example, collection systems and methods for managing insurance subrogation claims) described above. The methods described above can be implemented in computer-executable instructions (for example, organized in program modules). The program modules can include the routines, programs, objects, components, and data structures that perform the tasks and implement the data types for implementing the techniques described above.

While FIG. 24 shows a typical configuration of a desktop computer, the technologies may be implemented in other computer system configurations, including multiprocessor systems, microprocessor-based or programmable consumer electronics, minicomputers, mainframe computers, and the like. The technologies may also be used in distributed computing environments where tasks are performed in parallel by processing devices to enhance performance. For example, tasks can be performed simultaneously on multiple computers, multiple processors in a single computer, or both. In a distributed computing environment, program modules may be located in both local and remote memory storage devices. For example, code can be stored on a local machine/server for access through the Internet, whereby data can be uploaded and processed by the local machine/server and the results provided for printing and/or downloading.

The computer system shown in FIG. 24 is suitable for implementing the technologies described herein and includes a computer 2420, with a processing unit 2421, a system memory 2422, and a system bus 2423 that interconnects various system components, including the system memory to the processing unit 2421. The system bus may comprise any of several types of bus structures including a memory bus or memory controller, a peripheral bus, and a local bus using a bus architecture. The system memory includes read only memory (ROM) 2424 and random access memory (RAM) 2425. A nonvolatile system (for example, BIOS) can be stored in ROM 2424 and contains the basic routines for transferring information between elements within the personal computer 2420, such as during start-up. The personal computer 2420 can further include a hard disk drive 2427, a magnetic disk drive 2428, for example, to read from or write to a removable disk 2429, and an optical disk drive 2430, for example, for reading a CD-ROM disk 2431 or to read from or write to other optical media. The hard disk drive 2427, magnetic disk drive 2428, and optical disk 2430 are connected to the system bus 2423 by a hard disk drive interface 2432, a magnetic disk drive interface 2433, and an optical drive interface 2434, respectively. The drives and their associated computer-readable media provide nonvolatile storage of data, data structures, computer-executable instructions (including program code such as dynamic link libraries and executable files), and the like for the personal computer 2420. Although the description of computer-readable media above refers to a hard disk, a removable magnetic disk, and a CD, it can also include other types of media that are readable by a computer, such as magnetic cassettes, flash memory cards, DVDs, and the like.

A number of program modules may be stored in the drives and RAM 2425, including an operating system 2435, one or more application programs 2436, other program modules 2437, and program data 2438. A user may enter commands and information into the personal computer 2420 through a keyboard 2440 and pointing device, such as a mouse 2442. Other input devices (not shown) may include a microphone, joystick, game pad, satellite dish, scanner, or the like. These and other input devices are often connected to the processing unit 2421 through a serial port interface 2446 that is coupled to the system bus, but may be connected by other interfaces, such as a parallel port, game port, or a universal serial bus (USB). A monitor 2447 or other type of display device is also connected to the system bus 2423 via an interface, such as a display controller or video adapter 2448. In addition to the monitor, personal computers typically include other peripheral output devices (not shown), such as speakers and printers.

The above computer system is provided merely as an example. The technologies can be implemented in a wide variety of other configurations. Further, a wide variety of approaches for implementing the systems and methods of managing insurance subrogation claims are possible. For example, the systems and methods can be utilized on one computer system and presented on different computer systems as appropriate (e.g., as previously described utilizing network and server Internet and intranet technology). In addition, various software aspects can be implemented in hardware, and vice versa. For example, the described technologies can be practiced with other computer system configurations including Internet appliances, hand-held devices, wearable computers, cellular or mobile phones, a multi-processor system, microprocessor-based or programmable consumer electronics, set-top boxes, network PCs, mini-computers, mainframe computers and the like. The technologies can be embodied in a special purpose computer or data processor that is specifically programmed, configured or constructed to perform on or more computer-executable instructions. The term “computer,” as used generally herein, refers to any of the above devices or combination of devices, as well as any data processor.

The technologies can also be practiced in distributed computing environments, where tasks or modules are performed by remote processing devices, which are linked through a communications network, such as a Local Area Network (“LAN”), Wide Area Network (“WAN”) or the Internet. In a distributed computer environment, program modules or sub-routines may be located in both local and remote storage devices. Aspects of the technologies disclosed may be stored or distributed on computer-readable media, including magnetic and optically readable and removable computer discs, stored as firmware in chips (e.g., EEPROM chips), as well as distributed electronically over the Internet or over other networks (including wireless networks). Further portions of the technologies may reside on a server computer, while corresponding portions reside on a client computer. Data structures and transmission of data particular to aspects of the disclosed systems and methods can also be encompassed within the scope of the disclosed technologies. If more than one server computer is utilized, load balancing for distributing the processing load between two or more computers, to thereby more efficiently process instructions and route data can be utilized. Such load balancing can distribute message traffic, particularly during peak traffic times. Accordingly, a distributed file system which manages and transparently locates pieces of information (e.g., content pages) from remote files or databases and distributes files across the network, such as a LAN, can be utilized. A distributed file system can also manage read and write functions to databases.

While shown and described with web browsers, any application program for providing graphical user interface to users may be employed. Similarly, while a network of computers may have client-server architectures, in which a computer is dedicated to serving other client computers, it may also have architectures such as peer-to-peer, in which one or more computers serve simultaneously as servers and clients.

Exemplary server computers may include a server engine, a web page management component, a content management component and a database management component. A server engine can perform basic processing and operating system level tasks. A web page management component can handle creation and display or routing of web pages or screens during system access and utilization. Users (and computer systems) may access the server computer by means of a URL associated therewith. A content management component can handle many of the functions described in the methods disclosed. A database management component can include storage and retrieval tasks with respect to the database, queries to the database, and storage of data.

The disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

We claim:

1. A computerized collection system configured to manage one or more insurance subrogation claims, the system comprising:
a claim collector apparatus for obtaining subrogation claim information from one or more collection nodes of the collection system;
a claim storage device for storing the claim information;
a claim assessor apparatus for determining one or more collection events based at least on the claim information, and generating one or more subrogation documents based at least on the claim information and the one or more collection events; and
a claim presenter apparatus in communication with the one or more collection nodes for presenting at least one of the one or more subrogation documents and the claim information.

2. The system of claim 1, wherein the claim assessor apparatus determines the one or more collection events based on at least one of a stored civil procedure rule and a stored collection law rule.

3. The system of claim 1, wherein the one or more collection nodes comprises at least one collection node from the group consisting of:
a device operable by a person; and
a computer system.

4. The system of claim 3, wherein the one or more collection nodes comprises at least one computer system from the group consisting of:
an electronic insurance record system;
an electronic payment system;
an electronic judicial record system; and
an electronic communication system.

5. The system of claim 1, wherein subrogation claim information comprises at least one type of data selected from the group consisting of:
standardized data; and
claim specific data.

6. The system of claim 5, wherein the standardized data comprise at least one type of data selected from the group consisting of:
court data;
law enforcement data;
insurance company data;
process server data; and
attorney data.

7. The system of claim 6, wherein the standardized data comprises at least one type of information selected from the group consisting of:
one or more names;
contact information;
one or more policies; and
one or more fees.

8. The system of claim 7, wherein the claim specific data comprises at least one type of information selected from the group consisting of:
claimant information;
insured party information;
incident information;
damage information;
claim objective information; and
transaction information.

9. The system of claim 8, wherein the claim objective information comprises at least one type of objective selected from the group consisting of:
one or more pre-judgment objectives;
one or more litigation objectives; and
one or more post-judgment objectives.

10. The system of claim 9, wherein the claim objective information comprises one or more pre-judgment objectives, and the one or more pre-judgment objectives comprises at least one pre-judgment objective selected from the group consisting of:
a number of days after obtaining a claim before sending one or more initial letters;
a number of days after a verbal agreement before sending a promissory note;
a number of days after a payment is overdue before sending a payment reminder letter; and
a number of days after one or more lawsuit triggering events before filing a lawsuit.

11. The system of 10, wherein the claim objective information comprises at least a number of days after one or more lawsuit triggering events before filing a lawsuit, and the one or more lawsuit triggering events comprises at least one lawsuit triggering event selected from the group consisting of:
no response to the one or more initial letters;
no response to the promissory note;
no response to the payment reminder letter; and
a minimum number of days before a statute of limitations deadline.

12. The system of claim 9, wherein the claim objective information comprises one or more litigation objectives, and the one or more litigation objectives comprises at least one litigation objective selected from the group consisting of:
a number of days before a scheduled first court date before generating a trial outline;
a number of days after service of suit before sending a stipulated judgment;
a number of days after the earliest date allowed with no service before petitioning for a default judgment; and
a number of days after sending the stipulated judgment before petitioning for the default judgment.

13. The system of claim 9, wherein the claim objective information comprises one or more post-judgment objectives, and the one or more post-judgment objectives comprises at least one post-judgment objective selected from the group consisting of:
a number of days after a payment is overdue before sending a payment reminder letter;
a number of days after sending the payment reminder letter before suspending a driver's license;
a number of days after an earliest date in which it is legal to suspend the driver's license before suspending the driver's license;
a number of days after suspending the driver's license before garnishing one or more bank accounts;
a number of days after a previous garnishment of the one or more bank accounts before another garnishment of the one or more bank accounts;
a number of days after suspending the driver's license before garnishing wages;
a number of days after the previous garnishment of the one or more bank accounts before garnishing wages;
a number of days after suspending the driver's license before performing an asset check;
a number of days after garnishing wages before performing an asset check;
a number of days after the previous asset check before performing another asset check;
a number of days before a judgment expiration date before renewing a judgment;
a determination of whether to close a case when a judgment is paid in full; and
a determination of whether to close a case when a claimant is bankrupt.

14. A method for processing an insurance subrogation claim, comprising:
receiving subrogation claim information;
storing subrogation claim information;
analyzing the subrogation claim information to determine one or more collection events based at least on the subrogation claim information;
generating one or more documents based on the one or more collection events.

15. The method of claim 14, further comprising determining one or more claim objectives from the received claim information.

16. The method of claim 14, wherein analyzing the subrogation case information to determine one or more collection events further comprises analyzing at least one applicable rule selected from the group consisting of:
a civil procedure rule; and
a collection law rule.

17. One or more computer-readable media comprising computer-executable instructions for performing the method of claim 14.

18. A computer-implemented method for managing an insurance subrogation claim, comprising:
obtaining subrogation claim information and claim objectives using a computer;
initiating one or more collection actions based on the claim information and claim objectives using the computer; and
displaying information relating to the one or more collection actions on a computer display.

19. The computer-implemented method of claim 18, further comprising receiving commands on an input device from one or more parties involved with the insurance subrogation claim.

20. The method of claim 19, wherein the one or more parties involved with the insurance subrogation claim comprises at least one party selected from the group consisting of:
a claimant;
a collection system administrator;
an insurance administrator;
an insurance adjustor;
an insured party; and
an attorney.
